(19) United States
(12) Patent Application Publication
(10) Pub. No.: US 2005/0086665 A1
(43) Pub. Date: Apr. 21, 2005

(54) Autonomous device driver

(75) Inventor: Koji Matsuura, Takatsuki (JP)

Correspondence Address: McDermott, Will & Emery, 600 13th Street, N.W., Washington, DC, 20005-3096, US

(73) Assignee: MATSUSHITA ELECTRIC INDUSTRIAL CO., LTD.

(21) Appl. No.: 10/895,066

(22) Filed: Jul. 21, 2004

(30) Foreign Application Priority Data
Oct. 16, 2003 (JP) 2003-356677

(51) Int. Cl. G06F 13/00

(52) U.S. Cl. 719/321

(57) ABSTRACT

In an information processing apparatus using an operating system, an autonomous device driver that is independent from a kernel is provided. An information processor 110 using a middleware support library 204 that operates independently from the operating system and has an application program interface 201 independent from specifications of hardware is provided. The middleware support library 204 compensates for a function not implemented in the hardware by software.

### BACKGROUND OF THE INVENTION

1. Field of the Invention

The present invention relates to an autonomous device driver that operates independently from a kernel of a system of an information processing apparatus including hardware, a device driver, and an application program. Furthermore, the present invention relates to an information processing apparatus having incorporated therein the autonomous device driver.

2. Description of the Background Art

In order to reduce a period of developing an information processing apparatus including hardware, a device driver, and an application program, various designing schemes have been suggested. In such designing schemes, an architecture of the information processing apparatus including an application layer, a library layer, an operating system layer, and a hardware layer is suggested. In this architecture, software of the application layer operates on software of the library layer, and software of the library layer operates on software of the operating system layer.

The software of the operating system layer operates on hardware of the apparatus, and includes a kernel and a device driver that operates on the kernel and interfaces with the hardware. To import the software of the library layer and the software of the application layer to different hardware systems and different operating systems, all you have to do is to change a module of the operating system layer that provides services to the software of the library layer. With this structure, software portability can be enhanced, thereby reducing the period of developing the information processing apparatus.

With reference to FIG. 10, an information processing apparatus suggested in Japanese National Phase PCT Laid-Open Publication No. 2001-503891 is briefly described below as an example of a hierarchical structure of hardware and software of a conventional information processing apparatus. An information processing apparatus PI_C includes an application program 101, middleware 102, a device driver group 103_C, a kernel 104, an operating system 105_C, a peripheral module group 106_C, a CPU core 107, a CPU 108_C, a memory 109, and an information processor 110_C. The application program 101 operates by using a supporting logic of the middleware 102. The middleware 102 operates by using a supporting logic of the operating system 105_C.

The operating system 105_C includes the device driver group 103_C and the kernel 104. The device driver group 103_C operates by using a supporting logic of the kernel 104, and includes a logic for providing the function of the peripheral module group 106_C to the middleware 102. The kernel 104 operates by using the functions of the CPU core 107 and the memory 109, and includes a logic of supporting the device driver group 103_C and the middleware 102. The information processor 110 C includes the CPU 108_C and the memory 109.

The CPU 108_C includes the peripheral module group 106_C and the CPU core 107. The device driver group 103_C includes n (n is an arbitrary natural number) device drivers DD1 through DDn, while the peripheral module group 106_C includes n modules ML1 through MLn. The device drivers DD1 through DDn have a one-to-one correspondence with the modules ML1 through MLn. Basically, the information processor 110_C is structured by hardware, while the other elements are structured by software.

When developing software, consideration is given to software portability. Normally, in order to improve the portability of software, a scheme of dividing software into a plurality of layers and defining a standard application program interface for each layer is adopted. With this scheme, an influence from software changes in one layer can be blocked by its standard application program so as not to be exerted on another layer. Also in the information processing apparatus PI_C exemplarily shown in FIG. 10, the software layer is divided into a plurality of layers to improve software portability.

However, the device driver is designed to operate on the kernel of the operating system, that is, to operate dependently on the kernel. Therefore, when the operating system of the information processing apparatus is changed, the device driver group and the device drivers included therein have to be corrected, which is a problem in view of software portability. That is, in order to quickly develop the information processing apparatus, it is highly desirable that a series of operations, such as designing, creating, checking and correcting components (for example, device drivers), and an operation of developing the kernel be concurrently performed by a plurality of engineers in a distributed manner on a component or operation basis. However, as described, the device driver group has to be corrected when the specifications of the operating system (kernel) are changed, thereby making it difficult to perform such concurrent operations by a plurality of engineers.

As for so-called maintenance, such as adding a new function, changing a function, and debugging, it would be efficient if only the device driver achieving the function to be maintained is added, changed, or debugged. In practice, however, the entire device driver group and module group have to be maintained. Moreover, the device driver group uses a service routine of the kernel, and therefore debugging software is difficult. Still further, the kernel is a black box for device driver developers, in a broad sense. This increases the difficulty in debugging the device drivers that are dependent on the kernel.

Such a kernel-dependent device driver operating on the kernel makes it difficult to perform concurrent operations by a plurality of engineers to develop the information processing apparatus. Moreover, a maintenance operation has to be performed also on device drivers other than that having the function to be changed. This makes it difficult to timely perform quick maintenance at low cost.

Therefore, an object of the present invention is to provide an autonomous device driver independent from a kernel and allowing an operating system and other components included in an information processing apparatus to be concurrently developed and changed on a component or task basis and be maintained on a function basis, and an information processing apparatus using the autonomous device driver.

### SUMMARY OF THE INVENTION

In an information processing apparatus whose function is achieved through software in the form of an application program, middleware, and an operating system inclusive of a kernel, and through hardware having a CPU that includes a plurality of peripheral modules inclusive of an autonomous peripheral module that is independent from the kernel, an autonomous device driver that provides the middleware with a function of the autonomous peripheral module, the autonomous device driver including:
function collecting logic means that collects the function of the autonomous peripheral module; function reconstructing logic means that reconstructs the collected function so that the function is independent from specifications of the autonomous peripheral module; and application program interface means that provides the reconstructed function to the middleware.

As described above, the autonomous device driver is independent from the kernel. Therefore, the kernel and the autonomous device driver can be concurrently developed. Also, when the specifications of the kernel are changed, the autonomous device driver does not have to be corrected. Furthermore, even when the system is configured at low cost without using a kernel, the autonomous device driver does not have to be corrected. Still further, since the autonomous device driver does not use a service routine of a kernel, debugging software is easy. Still further, the autonomous device driver can be maintained without consideration of the kernel.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of an information processing apparatus according to the present invention;

FIG. 2 is a block diagram showing the structure of a middleware support library according to a first embodiment of the present invention;

FIG. 3 is a flowchart showing the operation of a function selector shown in FIG. 2;

FIG. 4 is a block diagram showing the structure of a middleware support library according to a second embodiment of the present invention;

FIG. 5 is a flowchart showing the operation of a function selector shown in FIG. 4;

FIG. 6 is a block diagram showing the structure of a middleware support library according to a third embodiment of the present invention;

FIG. 7 is a flowchart showing the operation of a function selector shown in FIG. 6;

FIG. 8 is a block diagram showing the structure of a middleware support library according to a fourth embodiment of the present invention;

FIG. 9 is a flowchart showing the operation of a function selector shown in FIG. 8; and

FIG. 10 is a block diagram showing the structure of a conventional information processing apparatus.

### DESCRIPTION OF THE PREFERRED EMBODIMENTS

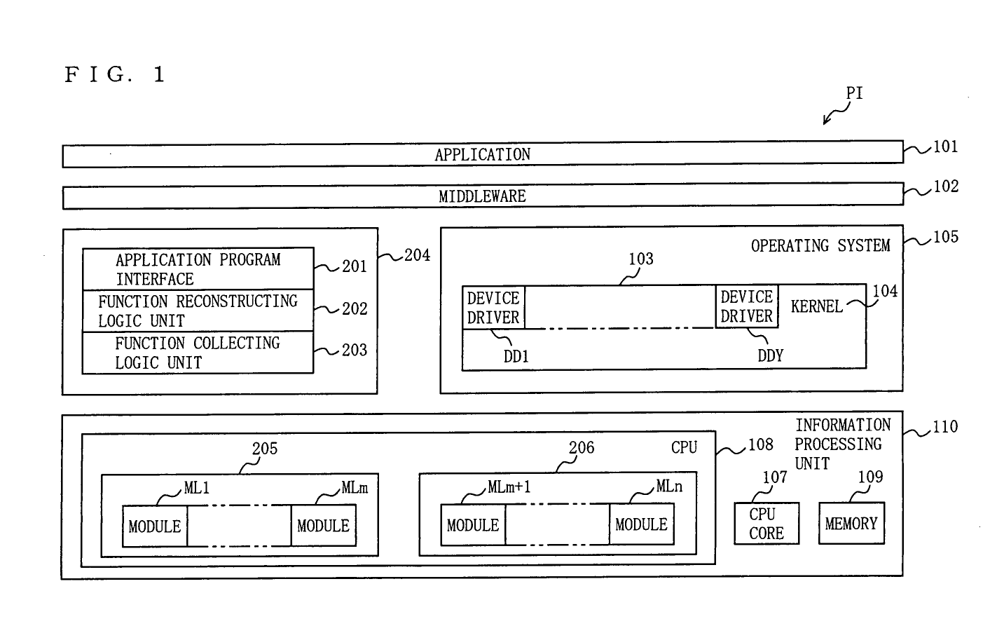

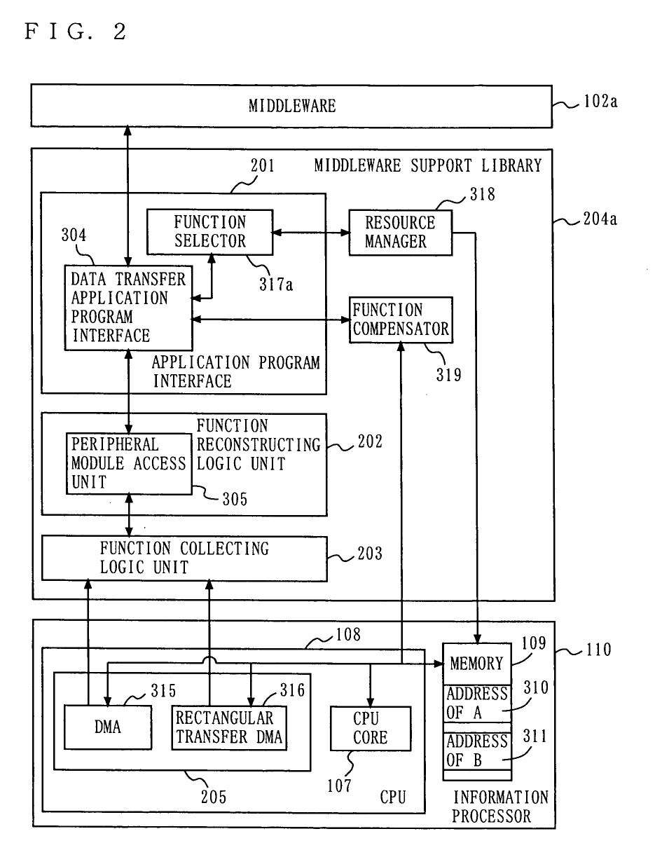

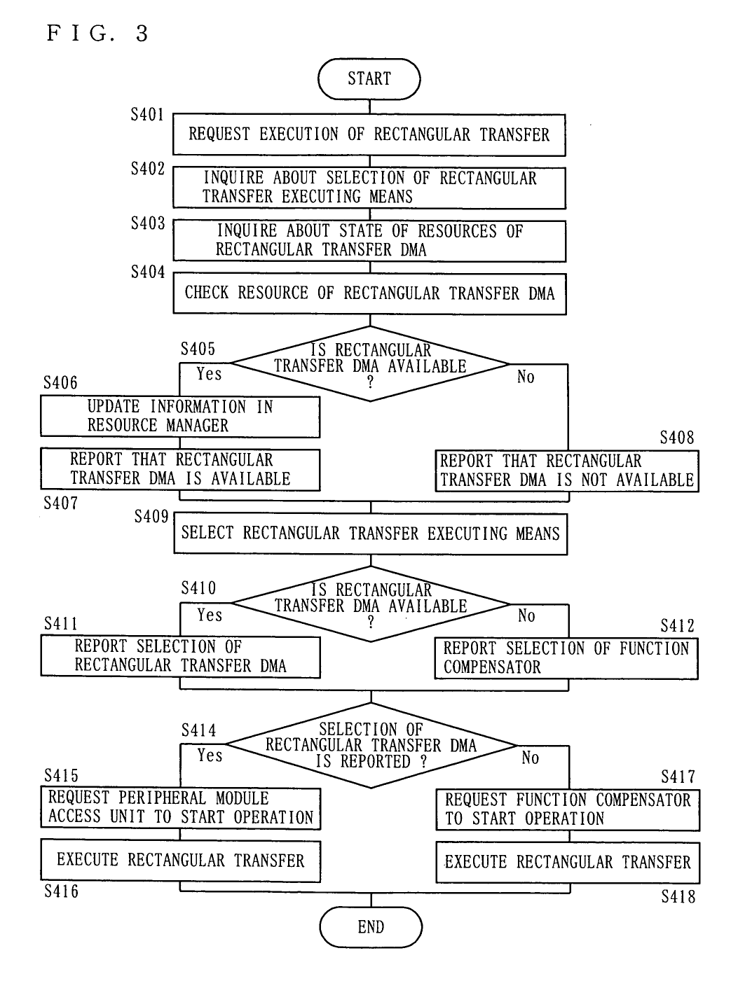

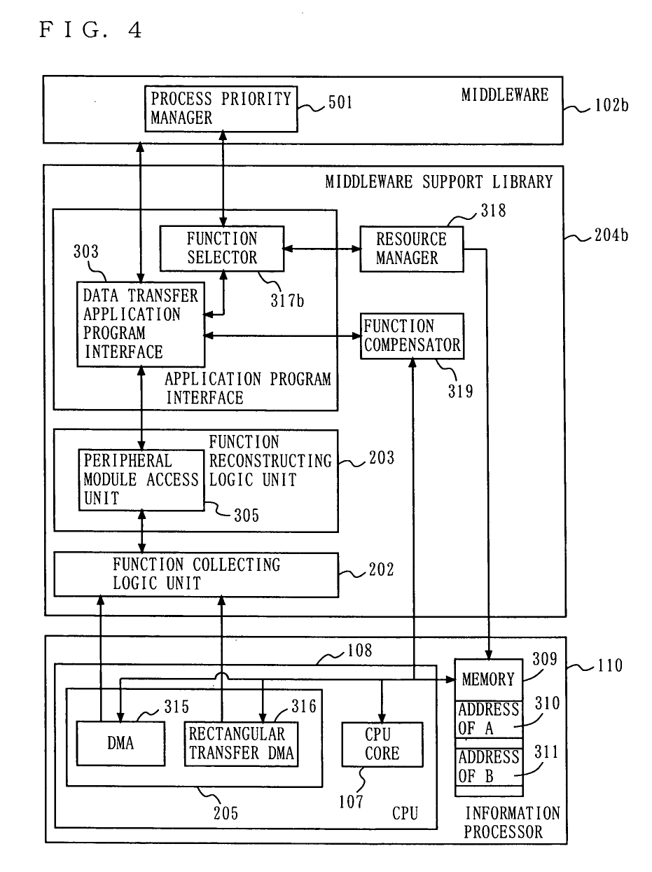

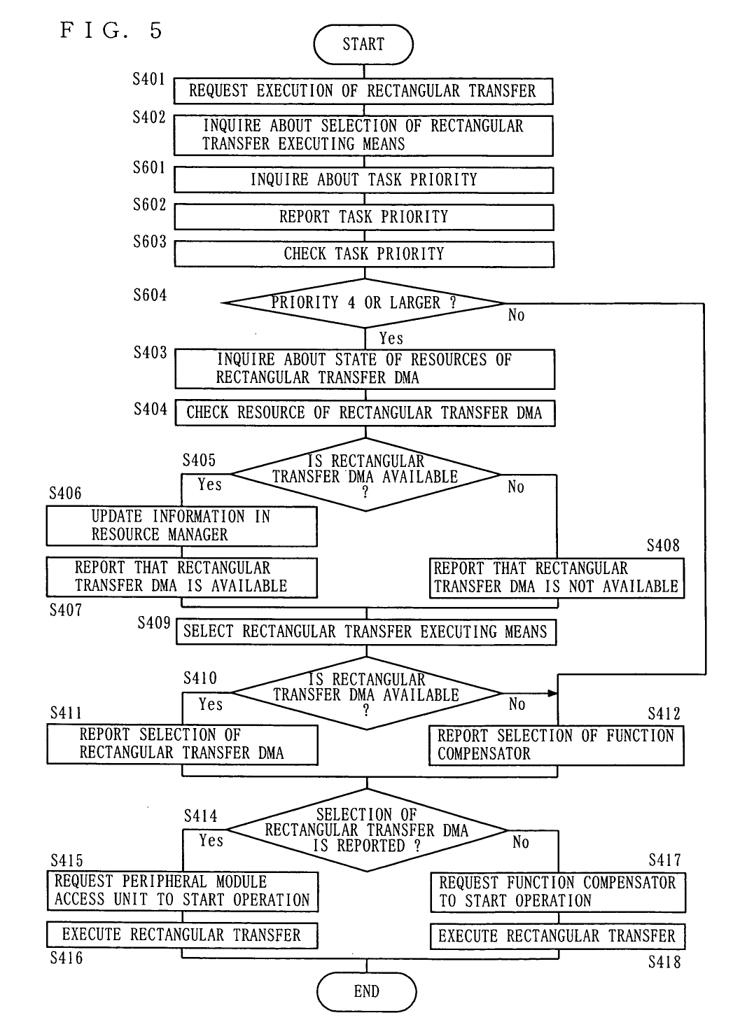

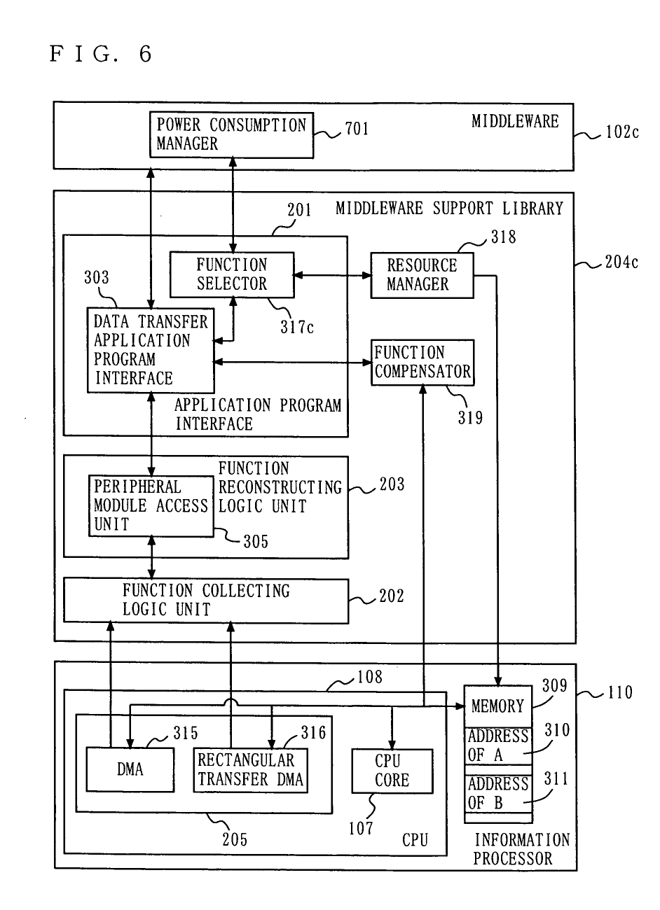

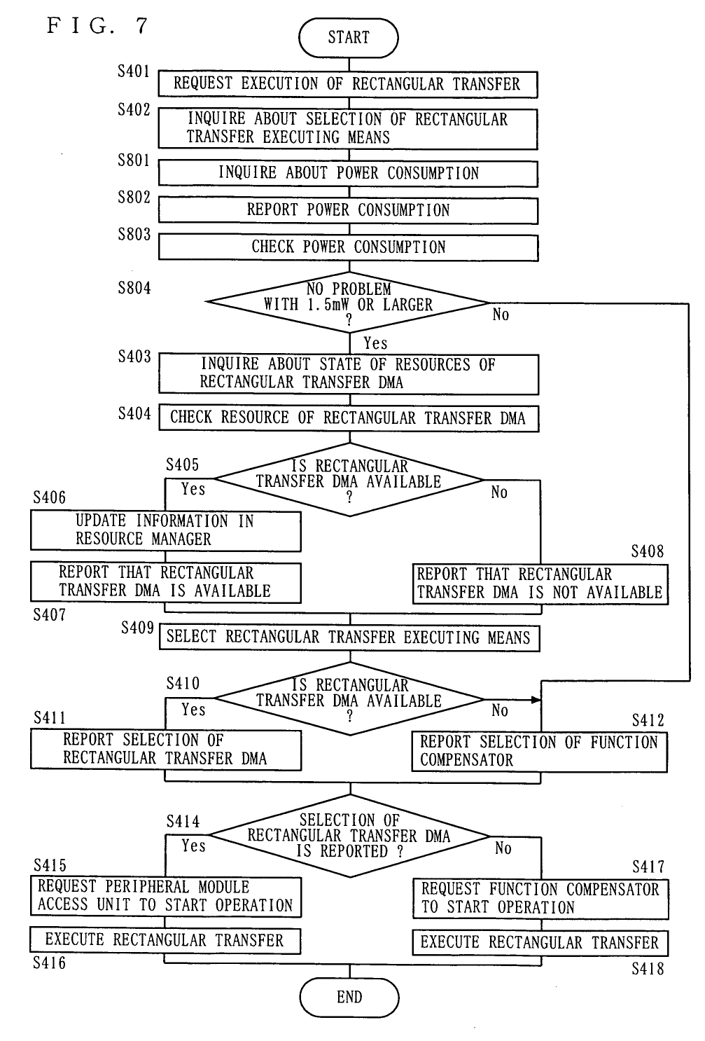

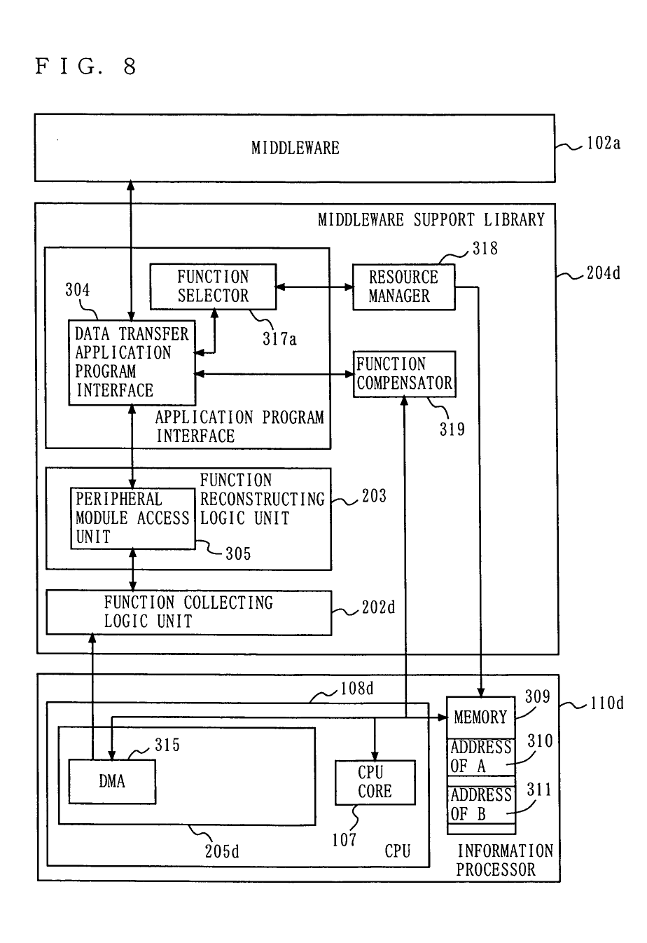

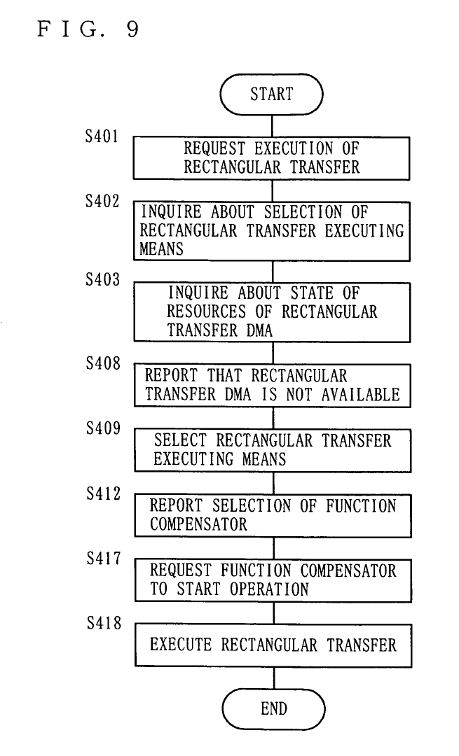

First, with reference to FIG. 1, a basic concept of the present invention is described. Then, a first embodiment of the present invention is described with reference to FIGS. 2 and 3, a second embodiment of the present invention is described with reference to FIGS. 4 and 5, a third embodiment of the present invention is described with reference to FIGS. 6 and 7, and then a fourth embodiment of the present invention is described with reference to FIGS. 8 and 9. FIG. 1 illustrates a hierarchical structure of hardware and software of an information processing apparatus according to the present invention.

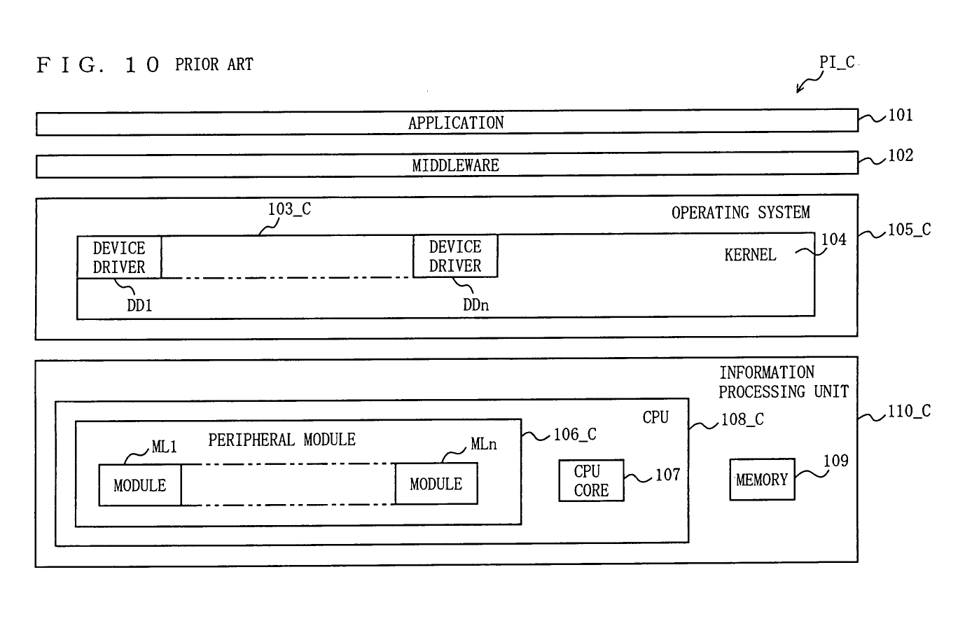

An information processing apparatus PI includes an application program 101, middleware 102, an operating system 105, an information processor 110, and a middleware support library 204. That is, the information processing apparatus PI is similar in structure to the information processing apparatus PI_C shown in FIG. 10 except that the operating system 105_C and the information processor 110_C are replaced by the operating system 105 and information processor 110 and the middleware support library 204 is newly added. Note that the middleware support library 204 is arranged in parallel to the operating system 105 between the middleware 102 and the information processor 110.

The middleware support library 204 includes an application program interface 201, a function reconstructing logic unit 202, and a function collecting logic unit 203. Note that the middleware support library 204 functions as an autonomous device driver that is independent from the kernel.

The information processor 110 includes a CPU 108 and a memory 109. That is, the information processor 110 is similar in structure to the information processor 110_C except that the CPU 108_C is replaced by the CPU 108. Furthermore, the CPU 108 includes an autonomous peripheral module group 205 that is independent from a kernel of the system and a dependent peripheral module that is dependent on the kernel. The CPU 108 is similar in structure to the CPU 108_C except that the n modules ML1 through MLn are replaced by the autonomous peripheral module group 205 including m (m=n−Y, where Y is a natural number smaller than n) autonomous modules ML1 through MLm and a dependent peripheral module group 206 including Y (Y=n−m) dependent modules MLm+1 through MLn. Here, the autonomous peripheral module group 205 is a module group including modules each of which corresponds to a device driver that is independent from the kernel. Also, the depending peripheral module group 206 is a module group including modules each of which corresponds to a device driver that is dependent on the kernel.

Note that reference characters of the modules in the CPU 108 and the CPU 108_C are provided merely for identification. The modules having the same reference characters are not necessarily identical to each other.

The operating system 105 includes a dependent device driver group 103 including a kernel 104 and Y dependent device drivers DD1 through DDY. The dependent device driver group 103 operates by using a support logic of the kernel 104, and includes a logic that provides the function of the depending peripheral module 206 to the middleware 102. The kernel 104 operates by using the functions of the CPU core 107 and the memory 109, and includes a supporting logic of the dependent device driver group 103 and the middleware 102. That is, of the n device drivers DD1 through DDn in the operating system 105_C, only the Y dependent device driver DDm+1 through DDY are included in the operating system 105. Note that the device drivers DD in the dependent device driver group 103 have a one-to-one correspondence with the modules in the dependent peripheral module group 206 of the CPU 108.

Also, (n−Y) autonomous device drivers DDY+1 through DDn independent from the kernel are implemented as the middleware support library 204. In this sense, as required, the middleware support library 204 may be also hereinafter referred to as an autonomous device driver 204.

Specifically, the middleware support library (autonomous device driver) 204 includes an application program interface 201, a function reconstructing logic unit 202, and a function collecting logic unit 203. The function collecting logic unit 203 collects the function of the autonomous peripheral module group 205. The function reconstructing logic unit 202 reconstructs the function collected by the function collecting logic unit 203 so that the function is independent from the specifications of the autonomous peripheral module group 205. The application program interface 201 provides the function reconstructed by the function reconstructing logic unit 202 to the middleware 102.

As such, in the present invention, the peripheral modules are managed by the autonomous peripheral module group 205 independent from the kernel and the dependent peripheral module group 206 dependent on the kernel. The dependent peripheral module group 206 is supported by the dependent device driver group 103, as is the case of the conventional information processing apparatus. On the other hand, as for the autonomous peripheral module group 205, its function reconstructed so as to be independent from the specifications of the kernel is achieved by the middleware support library (autonomous device driver) 204. One feature of the present invention resides particularly in the middleware support library 204 and also in the middleware 102 and the information processor 110. Hereinafter, the middleware support library 204, the application program 101, and the information processor 110 of each embodiment are described in detail.

### First Embodiment

FIG. 2 illustrates middleware 102a, an information processor 110, and a middleware support library 204a in an information processing apparatus PIa (not shown) according to the first embodiment. The middleware 102a is identical in structure to that of the information processing apparatus PI_C shown in FIG. 10 but, for convenience of description, is provided with a different reference character 102a for differentiation. The middleware support library 204a includes the application program interface 201, the function collecting logic unit 203, a resource manager 318, and a function compensator 319.

The application program interface 201 includes a data transfer application program interface 304 and a function selector 317a. The function reconstructing logic unit 202 includes a peripheral module access unit 305.

The information processor 110 includes the memory 109, the CPU core 107, and the CPU 108. The CPU 108 includes the autonomous peripheral module group 205 and the dependent peripheral module group 206. Here, since one feature of the present invention resides in a relationship between the autonomous peripheral module group 205 and the middleware support library 204, the dependent peripheral module group 206 is not shown in FIG. 2 due to limited space. The autonomous peripheral module group 205 includes a DMA 315 and a rectangular transfer DMA 316. The memory 109 includes an A address 310 and a B address 311. The DMA 315 has a function of transferring data stored at the A address 310 of the memory 109 to the B address of the memory 109. The rectangular transfer DMA 316 has a function of transferring rectangular data stored at the A address 310 of the memory 109 to the B address of the memory 109.

The function compensator 319 in the middleware support library 204a has a function of transferring, through a software process by the CPU 108, rectangular data stored in the A address 310 of the memory 109 to the B address 311 of the memory 109. The function collecting logic unit 203 collects the functions of the DMA 315 and the rectangular transfer DMA 316.

The function reconstructing logic unit 202 reconstructs the function of the autonomous peripheral module group 205 collected by the function collecting logic unit 203 as the peripheral module access unit 305 associated with data transfer processing. The peripheral module access unit 305 has a function of transferring data and the rectangular data stored in the A address of the memory 109 and to the B address of the memory 109.

In the application program interface 201, the data transfer application program interface 304 has an interface providing the function of transferring the data and the rectangular data stored in the A address 310 of the memory 109 to the B address 311 of the memory 109 to the middleware 102a.

The function compensator 319 includes a logic of transferring, through software processing, the rectangular data stored in the A address 310 of the memory 109 to the B address 311 of the memory. The resource manager 318 manages types of the functions implemented in the autonomous peripheral module group 205 and the state of use of the functions.

Based on the information regarding the autonomous peripheral module group 205 managed by the resource manager 318, the function selector 317a selects (determines) either one of the function of the peripheral module access unit 305 and the function compensator 319 for use, and then reports the selection result to the data transfer application program interface 304.

Next, with reference to a flowchart shown in FIG. 3, the operation of the middleware support library 204a is specifically described. In the flowchart, an operation when the middleware 102a requests for rectangular transfer of data to the middleware support library 204a is shown.

That is, in step S401, a data rectangular transfer request is output from the middleware 102a to the data transfer application program interface 304. The control procedure then goes to the next step S402.

In step S402, the data transfer application program interface 304 inquires of the function selector 317 about which of the function of the peripheral module access unit 305 or the function of the function compensator 319 is used for executing rectangular transfer. The control procedure then goes to the next step S403.

In step S403, the function selector 317a inquires of the resource manager 318 about the state of resources of the rectangular transfer DMA 316. The control procedure then goes to the next step S404.

In step S404, the resource manager 318 checks the state of the resources of the rectangular transfer DMA 316. The control procedure then goes to the next step S405.

In step S405, it is determined whether the rectangular transfer DMA 316 is available. If it is available, Yes is determined, and then the control procedure goes to the next step S406. On the other hand, if it is not available, No is determined, and then the control procedure goes to step S408.

In S406, the resource manager 318 updates management information. That is, the resource manager 318 changes information about the state of use of the rectangular transfer DMA 316 from “available” to “not available”, and keeps the information until a rectangular transfer process is completed. After the rectangular transfer process is completed, the resource manager 318 updates the information about the state of use of the rectangular transfer DMA 316 to “available”. The control procedure then goes to the next step S407.

In step S407, the resource manager 318 reports to the function selector 317a that the rectangular transfer DMA 316 is available. The control procedure then goes to the next step S409.

In step S408, the resource manager 318 reports to the function selector 317a that the rectangular transfer DMA 316 is not available. The control procedure then goes to the next step S410.

In step S410, based on the report issued in step S407 or S408, it is determined whether the rectangular transfer DMA 316 is available. If it is available, Yes is determined, and then the control procedure goes to step S411. On the other hand, if it is not available, No is determined, and then the control procedure goes to step S412.

In step S411, the function selector 317a determines that the rectangular transfer DMA 316 is to be used, and then reports to the data transfer application program interface 304 that the peripheral module access unit 305 (the rectangular transfer DMA 316) is selected. The control procedure then goes to the next step S414.

In step S412, the function selector 317a determines that the function compensator 319 is to be used, and reports to the data transfer application program interface 304 that the function compensator 319 is selected. The control procedure then goes to the next step S414.

In step S414, based on the report issued in step S411 or S412, it is determined whether either one of the rectangular transfer DMA and the function compensator 319 is available or not. In this example, it is determined whether the rectangular transfer DMA 316 is available or not. If Yes is determined, the control procedure goes to step S415. If No is determined, the control procedure goes to step S417.

In step S415, the data transfer application program interface 304 requests the peripheral module access unit 305 to start its operation. The control procedure then goes to the next step S416.

In step S416, a data rectangular transfer process is performed from the peripheral module access unit 305 to the rectangular transfer DMA 316. That is, the rectangular transfer DMA 316 transfers the rectangular data from the A address 310 of the memory 109 to the B address 311 of the memory 109. Then, the control procedure ends.

In step S417, the data transfer application program interface 304 requests the function compensator 319 to start its operation. The control procedure then goes to the next step S418. In step S418, a data rectangular transfer process is performed from the function compensator 319 to the CPU 108. That is, the function compensator 319 transfers the rectangular data from the A address 310 of the memory 109 to the B address 311 of the memory 109. Then, the control procedure ends.

As described above, in the present embodiment, even when the function of the peripheral module cannot be used, a predetermined application program interface can always be provided to the middleware.

### Second Embodiment

FIG. 4 illustrates middleware 102b, the information processor 110, and a middleware support library 204b in an information processing apparatus PIb (not shown) according to the second embodiment. That is, in the present embodiment, the middleware 102a and the middleware support library 204a according to the first embodiment are replaced by the middleware 102b and the middleware support library 204b. Specifically, the middleware 102b is similar in structure to the middleware 102a except that a process priority manager 501 is added. Furthermore, the middleware support library 204b is similar to the middleware support library 204a except that the function selector 317a is replaced by a function selector 317b.

As described above, in the first embodiment, either one of the peripheral module access unit 305 and the function compensator 319 is selected based on the state of use of the peripheral module. In the present embodiment, an executing means is selected based on the priority of the process for which the middleware 102b requests the middleware support library 204b. That is, the function selector 317b determines (selects) either one of the function of either one of the peripheral module access unit 305 and the function of the function compensator 319 for use based on the information managed by the resource manager 318 and the information supplied from the process priority manager 501, and then reports the selection result to the data transfer application program interface 304.

With reference to a flowchart shown in FIG. 5, the operation in the present embodiment is specifically described. The flowchart shown in FIG. 5 is similar to that shown in FIG. 3 except that steps S601, S602, S603, and S604 are provided between steps S402 and S403. Note that step S604 is a decision step. If Yes is determined, the control procedure goes to the above-described step S403. If No is determined, the control procedure goes to the above-described step S412. Hereinafter, description is made particularly to the steps added in the present embodiment.

That is, in step S401, the middleware 102b outputs a data rectangular transfer request to the data transfer application program interface 304. Then, in step S402, the data transfer application program interface 304 inquires of the function selector 317b about which one of the function of the peripheral module access unit 305 and the function of the function compensator 319 is used for executing rectangular transfer. Then, the control procedure goes to the next step S601.

In step S601, the function selector 317b inquires of the process priority manager 501 about the priority of a task to be executed. The control procedure then goes to the next step S602.

In step S602, the priority of the task inquired about is reported from the process priority manager 501 to the function selector 317b. The control procedure then goes to the next step S603.

In step S603, the function selector 317b checks the reported priority of the task. The control procedure then goes to the next step S604.

In step S604, it is determined whether the reported priority of the task has a predetermined value, for example, 4 or larger. If the priority has a value of 4 or larger, Yes is determined, and then the procedure goes to the above-described step S403. Then, as described above, the control procedure goes through steps S403 to S418 to the end. On the other hand, if the priority has a value smaller than 4, that is, a value of 3 or smaller, No is determined in step S604, and then the control procedure goes to step S412. Then, as described above, the control procedure goes through steps S412 to S418 to the end. However, as described above, the function selector 317a is replaced by the function selector 317b.

As described above, in the present embodiment, the process priority manager 501 reports the information about the processing priority of the task to be executed to the function selector 317b. If the processing priority has a value of 3 or smaller, the function selector 317b selects the function compensator 319. If the processing priority has a value of 4 or larger, as with the first embodiment, either one of the rectangular transfer DMA 316 and the function compensator 319 is selected based on the state of use of the rectangular transfer DMA 316. As such, the either one of the peripheral module access unit 305 and the function compensator 319 can be flexibly selected based on the processing priority of the request from the middleware 102b.

### Third Embodiment

FIG. 6 illustrates middleware 102c, the information processor 110, and a middleware support library 204c in an information processing apparatus PIc (not shown) according to the third embodiment of the present invention. The present embodiment is similar to the second embodiment except that the middleware 102b and the middleware support library 204b are replaced by the middleware 102c and the middleware support library 204c. Specifically, the middleware 102c is similar to the middleware 102b except that the process priority manager 501 is replaced by a power consumption manager 701. Furthermore, the middleware support library 204c is similar to the middleware support library 204b except that the function selector 317b is replaced by a function selector 317c.

As described above, in the first embodiment, either one of the peripheral module access unit 305 and the function compensator 319 is selected based on the state of use of the peripheral module. Furthermore, in the second embodiment, either one of the peripheral module access unit 305 and the function compensator 319 is selected based on the priority of the process. In the present embodiment, either one of the peripheral module access unit 305 and the function compensator 319 is selected based on the power consumption required for execution of a task requested by the middleware 102c to the middleware support library 204c.

That is, the function selector 317c selects either one of the function of the peripheral module access unit 305 and the function of the function compensator 319 based on the information managed by the resource manager 318 and information (a power consumption request) supplied from the power consumption manager 701, and then reports the selection result to the data transfer application program interface 304. In the present example, it is assumed that power consumption required for the information processor 110 to execute the rectangular transfer DMA 316 is 2 mW, while power consumption required for the information processor 110 to execute the function compensator 319 is 1 mW.

Next, with reference to a flowchart shown in FIG. 7, a specific operation of the middleware support library 204c is described. The flowchart of FIG. 7 is similar to that of FIG. according to the second embodiment except that steps S601, S602, S603, and S604 are replaced by steps S801, S802, S803, and S804, respectively. Hereinafter, description is made particularly to those new steps.

That is, in step S401, the middleware 102c outputs a data rectangular transfer request to the data transfer application program interface 304. Then, in step S402, the data transfer application program interface 304 inquires of the function selector 317c about which one of the function of the peripheral module access unit 305 and the function of the function compensator 319 is used for executing rectangular transfer. The control procedure then goes to the next step S801. The control procedure then goes to the next step S801.

In step S801, an inquiry about power consumption required for the information processor 110 to execute the requested task is issued from the function selector 317c to the power consumption manager 701. The control procedure then goes to the next step S802.

In step S802, the power consumption manager 701 reports the power consumption of the task to the function selector 317c. The control procedure goes to the next step S803.

In step S803, the function selector 317c checks the reported power consumption. The control procedure then goes to the next step S804.

In step S804, it is determined whether there is a problem even with the reported power consumption having a predetermined value, for example, 1.5 mW or larger. If there is no problem, Yes is determined, and the control procedure then goes to the above step S403. Then, as described above, the control procedure goes through steps S403 to S418 to the end. On the other hand, if there is a problem, No is determined, and the control procedure goes to step S412. Then, as described above, the control procedure goes through steps S412 to S418 to the end. However, as described above, note that the function selector 317b is replaced by the function selector 317c.

If there is a problem with the power consumption of 1.5 mW or larger of the information processor 110, the function selector 317c selects the function compensator 319. If there is no problem with the power consumption of 1.5 mW or larger of the information processor 110, the control procedure goes to step S403. This is an example in which the power consumption required for the process of the function compensator 319 is smaller than that required for the process of the rectangular transfer DMA 316. When the power consumption required for the process of the function compensator 319 is smaller than that required for the process of the rectangular transfer DMA 316, the process in step S802 is changed.

As described above, in the present embodiment, either one of the peripheral module access unit 305 and the function compensator 319 can be flexibly selected based on the power consumption requested from the middleware 102 to the middleware support library 204c.

### Fourth Embodiment

FIG. 8 illustrates the middleware 102a, an information processor 110d, and a middleware support library 204d in an information processing apparatus PId (not shown) according to the fourth embodiment of the present invention. The present embodiment is similar to the first embodiment except that the middleware support library 204a and the information processor 110 are replaced by the middleware support library 204d and the information processor 110d. Specifically, the middleware support library 204d is similar to the middleware support library 204a except that the function reconstructing logic unit 202 is replaced by a function reconstructing logic unit 202d.

Furthermore, the information processor 110d is similar to the information processor 110 except that the CPU 108 is replaced by a CPU 108d. The CPU 108d is similar to the CPU 108 except that the autonomous peripheral module group 205 is replaced by an autonomous peripheral module group 205d. The autonomous peripheral module 205d is similar to the autonomous peripheral module 205 except that the rectangular transfer DMA 316 is removed.

Next, with reference to a flowchart shown in FIG. 9, the operation of the middleware support library 204d is specifically described. The flowchart shown in FIG. 9 is similar to that shown in FIG. 3 according to the first embodiment except that steps S404, S405, S406, S407, S410, S411, S414, S415, and S416 are removed. Hereinafter, description is made particularly to a feature unique to the present embodiment.

That is, in step S401, the middleware 102a outputs a data rectangular transfer request to the data transfer application program interface 304. Then, in step S402, the data transfer application program interface 304 inquires of the function selector 317a about which one of the function of the peripheral module access unit 305 and the function of the function compensator 319 is used for executing rectangular transfer.

In step S402, the data transfer application program interface 304 inquires of the function selector 317d about which one of the function of the peripheral module access unit 305 and the function of the function compensator 319 is used for executing rectangular transfer. In step S403, the function selector 317a inquires of the resource manager 318 about the state of resources of the rectangular transfer DMA 316.

In step S408, the resource manager 318 reports to the function selector 317a that the rectangular transfer DMA 316 is not available. This is because no rectangular transfer DMA is implemented in the autonomous peripheral module group 205d. In step S412, the function selector 317a determines that the function compensator 319 is used, and reports to the data transfer application program interface 304 that the function compensator 319 has been selected.

In step S417, the data transfer application program interface 304 requests the function compensator 319 to start operation. Then in step S418, the function compensator 319 executes data rectangular transfer on the CPU 108d. That is, the rectangular data is transferred by the function compensator 319 from the A address 310 of the memory 109 to the B address of the memory 109. Then, the control procedure ends.

As described above, in the present embodiment, even when the peripheral module does not have a specific function implemented therein, a predetermined application program interface can always be provided to the middleware. Also, the autonomous device driver according to the present invention can be used for information processing apparatuses each including hardware, a device driver, and an application program, and digital home electrical products such as digital televisions and cellular phones.

While the invention has been described in detail, the foregoing description is in all aspects illustrative and not restrictive. It is understood that numerous other modifications and variations can be devised without departing from the scope of the invention.

1. In an information processing apparatus whose function is achieved through software in the form of an application program, middleware, and an operating system inclusive of a kernel, and through hardware having a CPU that includes a plurality of peripheral modules inclusive of an autonomous peripheral module that is independent from the kernel, an autonomous device driver that provides the middleware with a function of the autonomous peripheral module, the autonomous device driver comprising:
function collecting logic means that collects the function of the autonomous peripheral module;
function reconstructing logic means that reconstructs the collected function so that the function is independent from specifications of the autonomous peripheral module; and
application program interface means that provides the reconstructed function to the middleware.

2. The autonomous device driver according to claim 1, wherein
the function reconstructing logic means includes peripheral module accessing means that allows the application program interface means to access the autonomous peripheral module.

3. The autonomous device driver according to claim 2, further comprising
a memory that store software including a logic executed on the information processing apparatus, wherein
the middleware includes a logic for supporting the application.

4. The autonomous device driver according to claim 1, further comprising
function compensating means that achieves a function implemented in any one of the peripheral modules and a function not implemented in the peripheral modules through a software process performed by the CPU.

5. The autonomous device driver according to claim 4, further comprising
resource managing means that stores, in the memory, information indicative of a type of the function implemented in the peripheral module and a state of use of each of the peripheral modules.

6. The autonomous device driver according to claim 5, wherein
when the function of the peripheral module is in use, the resource managing means updates the information indicative of the state of use so that the information indicates that the peripheral module is not available, and when the function of the peripheral module is not in use, the resource managing means updates the information indicative of the state of use so that the information indicates that the autonomous peripheral module is available.

7. The autonomous device driver according to claim 5, further comprising
function selecting means that determines either one of the peripheral module accessing means and the function compensating means for use based on information stored in the memory by the resource managing means.

8. The autonomous device driver according to claim 5, wherein
the middleware further includes process priority managing means that manages a priority of a process requested to the autonomous device driver, and
the function selecting means determines either one of the peripheral module accessing means and the function compensating means for use based on the information stored in the memory by the resource managing means and the priority managed by the process priority managing means.

9. The autonomous device driver according to claim 5, wherein
the middleware further includes power consumption managing means that manages power consumption of the information processing apparatus, and
the function selecting means determines either one of the peripheral module accessing means and the function compensating means for use based on the information stored in the memory by the resource managing means and power consumption information supplied from the power consumption managing means.
